(19) United States
(12) Patent Application Publication
(10) Pub. No.: US 2024/0230341 A1
(43) Pub. Date: Jul. 11, 2024

(54) CELESTIAL NAVIGATION WITH COMPUTER CONTROLLED DEAD RECONNING

(71) Applicants: Mikhail Belenkii, San Diego, CA (US); Timothy Brinkley, San Diego, CA (US)

(72) Inventors: Mikhail Belenkii, San Diego, CA (US); Timothy Brinkley, San Diego, CA (US)

(21) Appl. No.: 18/095,873

(22) Filed: Jan. 11, 2023

(51) Int. Cl. G01C 21/28; G06T 7/73

(52) U.S. Cl. CPC G01C 21/28; G06T 7/74; G06T 2207/10032; G06T 2207/10048; G06T 2207/30252

(57) ABSTRACT

A celestial navigation system (CNS) designed for determining position of a vehicle in GPS denied or degraded environment by imaging celestial objects and measuring vehicle ground speed, attitude, and time. Vehicle position is calculated by a processor using dead reconning navigation algorithm and heading measurements from celestial sensor, ground speed measurements from ground speed sensor, pitch and roll measurements from IMU, and time from the onboard clock

### FIELD OF THE INVENTION

The present invention relates to celestial navigation.

### BACKGROUND OF THE INVENTION

### Sky Charts

The position of celestial objects at any time at any place on earth is known with extremely high accuracy. These celestial objects include all recognizable stars and planets, the sun, and the moon. Accurate positioning of the celestial objects depends only on knowledge of the latitude and longitude positions within 1-3 km and on the date and time to within about 1 second of observation. Latitude and longitude generally can be determined easily with available maps or using dead reconning position determination scheme. Computer programs with astronomical algorithms are available that can be used to calculate the positions of any of these celestial objects at any time for any position on or near the surface of the earth. These computer programs are described in several good textbooks including Astronomical Algorithms by Jean Meeus, published by William-Bell with offices in Richmond Va. Techniques for using the programs to determine the positions of the celestial objects are clearly described in this reference. Software programs such as “The Sky” available from Software Bisque and “Guide” available from Project Pluto are used to provide planetarium information. Star pattern recognition computer programs are available in the prior art. A Two Micron All Sky Survey (2MASS) provides a Point Source Catalog (PSC) consisting of over 500 million stars and galaxies. It also provides an all-sky quick look and atlas images providing full coverage of the infrared sky.

### Naval Observatory Vector Astrometry Software (NOVAS)

NOVAS is an integrated package of subroutines and functions for computing various commonly needed quantities in positional astronomy. The package can provide, in one or two subroutine or function calls, the instantaneous coordinates of any star or planet in a variety of coordinate systems. At a lower level, NOVAS also supplies astrometric utility transformations, such as those for precession, nutation, aberration, parallax, and the gravitational deflection of light. The computations are accurate to better than one milliarcsecond. The NOVAS package is an easy-to-use facility that can be incorporated into data reduction programs, telescope control systems, and simulations. The U.S. parts of The Astronomical Almanac are prepared using NOVAS. Three editions of NOVAS are available for use with Fortran, C, and Python computer languages.

### Dead-reconning Navigation Technique

Dead-reconning consists of extrapolation of a “known” position to some future time. It involves measurement of direction of motion and distance traveled. For example, dead-reconning measurements relative to an initial position for an aircraft, include heading measurements using magnetic compass or gyroscopes and ground velocity measurements using Doppler radar. Vehicle position is calculated by integrating measured ground velocity speed and true heading. Prior to Global Positioning System (GPS), dead-reconning computations were the heart of every automated navigator. Dead reconning provides continuous navigation information between discrete fixes. In its simplest form dead reconning can calculate the position of a vehicle on the surface of a flat Earth from measurements of ground speed V_{g} and true heading ω_{T}:

$${V}_{north} = {V}_{g} cos {ω}_{T} ,$$

$$y - {y}_{0} = {\int }_{0}^{t} {V}_{north} dt$$

$${V}_{east} = {V}_{g} sin {ω}_{T} ,$$

$$x - {x}_{0} = {\int }_{0}^{t} {V}_{east} dt$$

Where x−x₀ and y−y₀ are the east and north distances traveled during the measured interval, respectively. The dead-reconning computations are described in several textbooks including Avionics Navigation Systems by Myron Kayton and Walter Fried published by John Willey& Sons. Inc in New York.

### Attitude Heading and Reference Systems

Attitude heading reference systems (AHRSs) include 3-axis sensors that provide heading, pitch, and roll information for moving platforms. AHRSs are designed to replace traditional mechanical gyroscopic instruments and provide superior reliability and accuracy. These systems consist of either solid-state or MEMS gyroscopes, accelerometers, and magnetometers on all three axes. Some of these systems use GPS receivers to improve long-term stability of the gyroscopes. A Kalman filter is typically used to compute solutions from these multiple sources. AHRSs differ from traditional inertial navigation systems (INSs) by attempting to estimate only attitude (e.g., pitch roll and yaw) states rather than attitude, position and velocity as is the case with an inertial navigation system (INS).

AHRSs are proving themselves to be highly reliable and are in common use, for example, in commercial and business aircraft. Recent advances in MEMS manufacturing have brought the price of Federal Aviation Administration certified AHRSs down to below $15,000.

A gyroscope provides an AHRS with a measurement of the system's angular rate. These angular rate measurements are then integrated to determine an estimate of the system's attitude. However, in order to determine the current attitude, an earlier attitude of the system must also be known. Over time, this calculated attitude drifts unboundedly from a “true” attitude of the system due to the inherent noise and bias properties of the gyroscope itself. Although gyroscopes are used to measure changes in orientation, without the absolute references from accelerometers and magnetometers the system accuracy quickly degrades. As such, when there are extended periods of interference or errors introduced into sensing of gravity or magnetic field performance of the system can be seriously compromised.

As a general reference, gravity is almost perfect—it is a constant force that is not influenced dramatically by anything. The most difficult error introduced in sensing gravity is the acceleration added during movements. Each time the platform is moved, acceleration is sensed, thus creating a potential for error. This however is easily mitigated by applying algorithms to the data that filter out such accelerations, resulting in a very accurate means of determining the vector of gravity. Note that this information is used only for initial setup and system corrections and is not needed for real-time tracking of orientation. Magnetic field disturbances are much more difficult to deal with.

Since the accelerometer can only measure pitch & roll, a magnetometer provides an AHRS with a measurement of yaw by comparing measurements of the magnetic field surrounding the system to Earth's magnetic field, just like a traditional magnetic compass. In most AHRS units, the magnetometer measurements have no impact on the pitch and roll angle estimates. While seemingly straightforward, using a magnetometer to accurately estimate the heading can actually prove to be quite challenging. The Earth's magnetic field is weak, so large metal structures, high power cables, or any other magnetic disturbances can distort Earth's magnetic field and cause errors in the estimated heading angle. Disturbances caused by objects to which the AHRS is fixed (e.g., the vehicle) can be compensated using a calibration known as hard & soft iron (HSI) calibration, but only when those disturbances are not time varying. Advanced filtering techniques can be used to mitigate the impact of external disturbances in the environment, but their effectiveness varies by manufacturer and application. Additionally, the magnetic North pole of the Earth is not in the same location as True North or the geographic North pole of the Earth. If the heading angle with respect to True North is desired, the declination angle between these two poles must be factored into the heading determination.

In an AHRS, the measurements from the gyroscope, accelerometer, and magnetometer are combined to provide an estimate of a system's orientation, often using a Kalman filter. This estimation technique uses raw measurements to derive an optimized estimate of the attitude, given the assumptions outlined for each individual sensor. The Kalman filter estimates the gyro bias, or drift error of the gyroscope, in addition to the attitude. The gyroscope bias can then be used to compensate the raw gyroscope measurements and aid in minimizing the drift of the gyroscope over time. By combining the data from each of these sensors into a Kalman filter, a substantially drift-free, high-rate orientation solution for the system can be obtained.

An AHRS typically includes a 3-axis gyroscope, a 3-axis accelerometer, and a 3-axis magnetometer to determine an estimate of a system's orientation. Each of these sensors contributes measurements to the combined system and each of the sensors exhibits unique limitations.

### Digital Magnetic Compass

Magnetic disturbances, which can be internal or external to the system, can pose a problem for a Digital Magnetic Compass (DMC) and cause the magnetometer of the DMC to measure a biased and distorted magnetic field. Internal magnetic disturbances are a result of the magnetic signature of the system to which the DMC is rigidly attached. They can be non-variable disturbances, such as a steel plate, or variable disturbances, such as motors or multi-rotors. External magnetic disturbances are caused by anything in the environment surrounding the system such as batteries, electronics, cars, rebar in concrete, and other ferrous materials. These magnetic disturbances lead to increased errors in the magnetometer measurements, causing errors in the estimates of the heading angle. To account for any non-variable magnetic disturbances internal to a system, a hard and soft iron calibration can be performed on the system. However, the user should understand that dead-reconning navigation technique using a DMC in the presence of magnetic interference could likely results in large position errors.

Magnetic compasses are typically accurate to only about one degree, and the presence of metal or other local disturbances will often reduce accuracy of the magnetic compasses to several degrees or render them useless. Also, magnetic compasses are highly sensitive to random errors caused by weakly magnetic disturbances (e.g. vehicles, power lines, buildings, etc.) and local variations of the earth's geo-magnetic field. These error sources are often random and cannot be accurately calibrated and modeled to be subtracted out. A large magnetic disturbance from hard or soft iron effects can result in an azimuth error of up to 30 to 60 degrees.

### Inertial Measurement Unit

An inertial measurement unit (IMU) is an electronic device that measures and reports a body's specific force, angular rate, and the orientation, using a combination of accelerometers, gyroscopes, and magnetometers. IMUs are typically used to maneuver aircraft (an attitude and heading reference system), including unmanned aerial vehicles (UAVs) among many others, and spacecraft, including satellites and landers. Recent developments allow for the production of IMU-enabled GPS devices. An IMU allows a GPS receiver to work when GPS-signals are unavailable, such as in tunnels, inside buildings, or when electronic interference is present. An inertial measurement unit works by detecting linear acceleration using one or more accelerometers and rotational rate using one or more gyroscopes. Some also include a magnetometer which is commonly used as a heading reference. Typical configurations contain one accelerometer, one gyroscopes, and one magnetometer per axis for each of the three principal axes: pitch, roll and yaw.

IMUs are often incorporated into Inertial Navigation Systems (INSs) which utilize the raw IMU measurements to calculate attitude, angular rates, linear velocity and position relative to a global reference frame. The IMU equipped INS forms the backbone for the navigation and control of many commercial and military vehicles such as crewed aircraft, missiles, ships, submarines, and satellites. IMUs are also essential components in the guidance and control of unmanned systems such as UAVs, unmanned ground vehicles (UGVs) and unmanned underwater vehicles (UUVs). Simpler versions of INSs termed AHRSs utilize IMUs to calculate vehicle attitude with heading relative to magnetic north. The data collected from the IMU's sensors allow a computer to track craft's position, using a method known as dead reckoning as explained above.

An IMU can be integrated into a GPS based automotive navigation systems or vehicle tracking systems, giving the system a dead reckoning capability and the ability to gather additional data about the vehicle's current speed, turn rate, heading, inclination and acceleration, in combination with the vehicle's wheel speed sensor output and, if available, reverse gear signal, for a variety of purposes.

A major disadvantage of using IMUs for navigation is that they typically suffer from accumulated error. Because the guidance system is continually integrating acceleration with respect to time to calculate velocity and position, any measurement errors, however small, are accumulated over time.

### Celestial Compasses

Celestial direction finding systems, known as Celestial Compasses, are known (for example, U.S. Pat. Nos. 8,471,906; 8,597,025; and 9,696,161, all of which one of the present inventors is the first named inventor). Celestial Compasses typically use celestial sighting of the sun, moon, or stars to provide absolute heading measurements. A Celestial Compass may include a 2-axis inclinometer, at least one camera for imaging at least one celestial object and a processor, which includes a celestial catalog with known positions (as a function of time) of the sun, moon, one or more stars. A processor includes the celestial catalog with known positions (as a function of time) of the sun, moon, and a large number of stars. And it is programmed with algorithms for automatically calculating heading based on the inclination of the system as measured by the inclinometer relative to the local vertical (gravity based) and the known position of at least one celestial object as provided by celestial catalog and as imaged by the camera. A daytime camera with a fisheye lens may be used to image the sun and a nighttime camera with a wide field-of-view (FOV) lens may be used to image stars.

Celestial Compasses have several limitations, which typically precludes their use on a moving platform. First, an inclinometer cannot discriminate between determine gravity force and acceleration and cannot determine gravity vector on a moving platform. Second, an exposure time of a night camera (0.8 sec) is normally too long for recording celestial images from a moving vehicle. Third, the azimuth accuracy of the daytime sensor decreases with an increase of the sun zenith angle. FIG. 1 shows dependence of the rms azimuth error on sun zenith angle. It is seen that at sun zenith angle of 15 deg the rms azimuth error is approximately by a factor of 4× greater than that at the zenith angle of ≥60 deg. This behavior is similar to a 1/sin (zenith angle) dependence. In addition, typically the rms azimuth error at daytime exceeds the rms azimuth error at night by a factor of about 2×-3×. The latter is because at night a 3-axis attitude can be determined by imaging 2 or more stars, and knowledge of the gravity vector is not required for azimuth determination. Consequently, the inclinometers errors and misalignment between optical axis of the fisheye lens and axes of the inclinometers can significantly affect azimuth accuracy.

### The Need

What is needed a device for determining the location and heading direction of a ground vehicle without input from GPS.

### SUMMARY OF THE INVENTION

The present invention provides a Celestial Navigation System (CNS) which uses dead reckoning techniques for calculating current position and heading of a vehicle by using a previously determined position then incorporating estimates of speed, heading direction and course over elapsed time. Periodic position fixes are provided by one or more celestial cameras systems which provide images of celestial objects which are compared by a computer processor programed with celestial catalogs, astronomical and dead reconning navigation algorithms to provide precise location of the vehicle when the celestial objects are viewable by one or more celestial cameras. The present invention also includes an onboard clock providing time, at least one speed sensor providing estimates of vehicle speed, and an inertial measurement unit (IMU) comprising three gyroscopes, three accelerometers and three magnetometers. The computer processor utilizes input from the on-board clock, the at-least one speed sensor and the IMU to calculate estimates of the position and heading of the vehicle when the celestial objects are not viewable. Position may be in terms of latitude and longitude. Preferred embodiments of the present invention also include a display monitor displaying a map of the region surrounding the vehicle for continuously displaying the position of the vehicle within the surrounding region

Embodiments of the present invention include celestial navigation systems (CSN) for determining location and direction of a moving vehicle utilizing computer controlled dead reconning without input from GPS. These embodiments include a computer processor system programed with dead reckoning techniques for calculating current position and heading of the vehicle by using previously determined position information along with current estimates of ground speed, heading direction and course over elapsed time. The processor is also programmed with one, or more, star catalogs. They also include an onboard clock providing time, a ground speed sensor adapted to provide current estimates of vehicle ground speed, an inertial measurement unit (IMU) comprising: three gyroscopes, three accelerometers and three magnetometers, and one or more celestial cameras systems adapted to image celestial objects. The computer processor system is adapted to compare images of the celestial objects to images of the celestial objects in the star catalogs to provide position and heading of the vehicle when the celestial objects are viewable by the one or more celestial cameras, and the computer processor is programed to utilizes input from the on-board clock, the at-least one ground speed sensor and the IMU to calculate estimates of the position and heading of the vehicle when the celestial objects are not viewable by the one or more celestial cameras.

### High Accuracy CNS

A preferred embodiments of the present invention provide a camera system that includes a telescope with a 1.45 μm long-pass filter and single SWIR camera, and IMU mounted on a mounting plate which is in turn mounted on the vehicle with vehicle adapting hardware. The telescope is mounted to point at about 30 degrees of vertical. The position of the vehicle is determined by the processor using a dead-reconning navigation algorithm and inputs from the onboard clock, odometer, low cost IMU, and star images recorded by the SWIR camera. The processor is programed with a star catalog, astronomical algorithm for providing the precise position of celestial objects such as stars and planets, the moon and the sun based on a precise (1 msec) input of time and approximate (several kilometers) observer position, and dead reconning navigation algorithm. Using celestial images recorded by the SWIR camera both day and night, high accuracy heading is determined. The heading information in conjunction with ground speed determined by odometer and elevation determined by IMU is used by the computer processor to calculate vehicle position using a dead-reconning navigation algorithm. Preferred embodiments can calculate positions of vehicles without input from GPS.

Because of the bright sky background, star imaging at daytime is challenging. A short-wave infrared (SWIR) sensor operating in the 1 μm-1.7 μm spectral band provides several principal benefits for imaging stars at daytime, as compared to visible-band (0.38 μm-0.7 μm) sensor. These benefits compared to prior art visible cameras include:
i) daytime sky background at longer wavelengths is lower by a factor of 8× than that in the visible band
ii) a number of IR stars is larger by a factor of 10× than the number of stars in the visible band
iii) a full well capacity of the SWIR camera is larger than typical visible light cameras (e.g., 800 Ke/pixel vs. 25 Ke/pixel); and
iv) effect of atmospheric obscurants & turbulence is lower at longer wavelength.

The embodiment determines heading by imaging stars at daytime and night. This embodiment does not require knowledge of the gravity vector, or local vertical, for heading determination.

### Low Size, Weight, and Power and Cost (SWaP-C) CNS

A low SWAP-C CNS embodiment of the present invention is a simpler two-camera system for separate day and night navigation with somewhat less precision as compared to the above-described embodiment. The camera system includes a fisheye lens with a neutral density (ND6) filter for daytime imaging of the sun and visible-band CMOS sensor without a filter for nighttime imaging of the stars. The day camera including a fisheye lens with FOV of 185 deg is mounted to point in the vertical direction for daytime celestial observations typically using the sun.

This low SWAP-C embodiment includes a separate camera with a much smaller field of view, about 6.4 degrees×4.9 degrees, for night-time imaging of stars. The second camera is mounted to point at about 30 degrees from vertical. This camera includes a 1″ lens and visible-band CMOS sensor. The two cameras and an IMU are linked to the processor, that records raw data (including images of celestial objects and IMU readings) and provides almost real time calculations. Because at daytime, only one celestial object, the sun can be imaged, a local vertical, or gravity vector from IMU is used for heading determination. Also, an attitude transfer alignment between the IMU to the day sensor is required. At night, when multiple (≥5) stars are detected in each data frame, the heading of the vehicle is determined directly from star measurements and knowledge of the gravity vector is not required.

### BRIEF DESCRIPTION OF THE DRAWINGS

FIG. 1 shows a dependence of the rms azimuth error at daytime on the sun zenith angle

FIG. 2 shows a block diagram of the High Accuracy Celestial Navigation System (HCNS) for ground vehicle.

FIG. 3 shows a dependence of the SNR on the aperture diameter for different number of averaged frames, N_{f} for daytime.

FIG. 4 shows a dependence of the SNR on the aperture diameter for different number of averaged frames, N_{f} for terminator & nighttime.

FIG. 5 a) shows a 3-D representation of the processed image obtained by averaging of 10 frames from the set, recorded using star tracker at daytime at angular distance from the sun of 100 degrees where the stellar brightness in camera counts is plotted along the vertical axis.

FIG. 5 b) depicts corresponding 2-D plot. The image spot size of the brightest star in the center of the plot spans over multiple pixels, where a spot size of a dim star includes only few pixels. The centroid accuracy is high in both cases due to high values of the SNR.

FIG. 6 shows a block diagram of the Low SWAP Celestial Navigation System (LCNS).

FIG. 7 shows azimuth error vs azimuth for polarization camera, which includes Sony polarization image sensor (IMX 264M). At 9:00 am the sun elevation angle is 24 degrees and rms azimuth error is 4 mrad; at 1:00 pm the sun elevation angle is 38 degrees and rms azimuth error is 9 mrad, and at 4:00 pm the sun elevation angle is 14 degrees and rms azimuth error is 4 mrad.

FIG. 8 describes a Leonardo DRS Data Distribution Unit—Expandable (DDUx) II.

FIG. 9 shows the average number of stars per one square degree vs star magnitude for SWIR (H-band) and Visible (V-band).

FIG. 10 shows experimental setup for flight demonstration of the proposed embodiment using FreeFly Astro industrial drone.

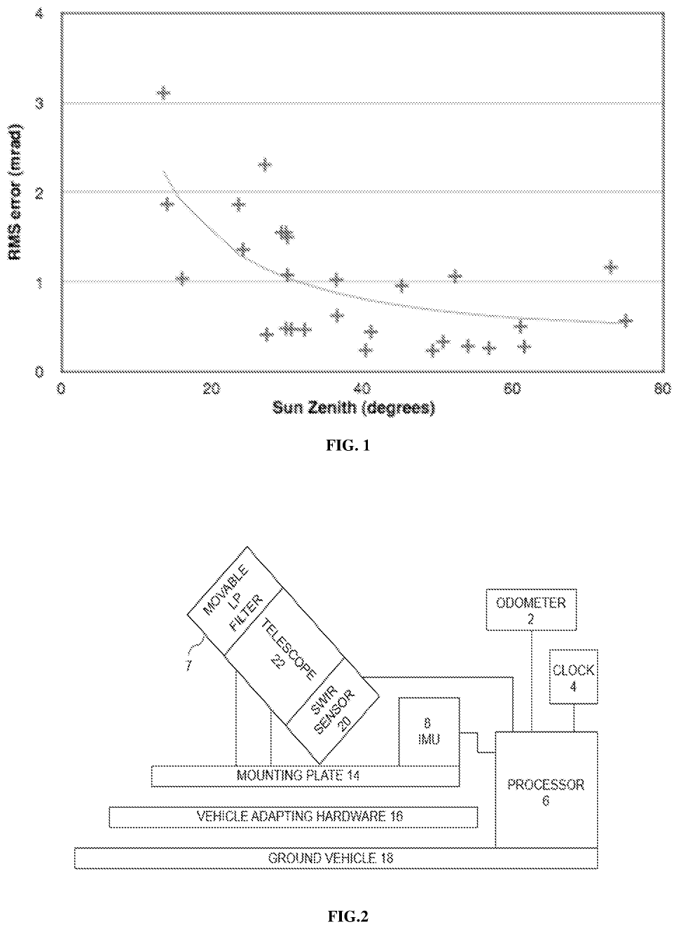

### DETAILED DESCRIPTION OF PREFERRED EMBODIMENTS

### High Accuracy CNS

Preferred embodiment of the present invention can be described by reference to the drawings. A preferred embodiment for high accuracy celestial navigation system is shown in FIG. 2. A preferred optical sensor, which includes a telescope 22 with a 1.45 μm long-pass filter 7 and SWIR sensor 20, and IMU 8 are mounted on a mounting plate 14 which is in turn mounted on the vehicle adapting hardware 16. The telescope is mounted to point at about 30 degrees of vertical. The position of the ground vehicle 18 is determined by computer processor 6 using dead-reconning navigation algorithm and inputs from the onboard clock 4, odometer 2, low cost IMU, and star images recorded by the SWIR camera system 23. The processor 6 is programed with a star catalog, astronomical algorithm for providing the precise position of celestial objects such as stars and planets, the moon and the sun based on a precise (1 msec) input of time and approximate (several kilometers) observer position, and dead reconning navigation algorithm. Using star images recorded by the SWIR camera system both day and night, high accuracy heading is determined. Using heading information in conjunction with ground speed determined by odometer and elevation determined by IMU, vehicle position is calculated by dead-reconning navigation algorithm without input from GPS.

Because of the daytime bright sky background, star imaging with visible light is difficult or impossible. The short-wave infrared (SWIR) sensor 20 operating in the spectral band, between 1 μm and 1.7 μm, provides several principal benefits for imaging stars at daytime, as compared to visible-band (0.38 μm-0.7 μm) sensors. These benefits have been described in detail above.

In this preferred embodiment, the CNS includes a three-inch telescope mounted on a mounting plate to point at about 30 degrees from vertical adopted for imaging stars at daytime and night with SWIR camera adopted for viewing a relatively small portion of the sky. This CNS includes movable 1.45 μm long-pass filter adapted to block portions of the sunlight to permit daytime viewing of the stars. The removable filter is removed for nighttime unblocked viewing of the stars, with the single SWIR camera system. This CNS may also include:
1) an odometer (driven by at least one wheel speed sensor),
2) an IMU,
3) a precision clock, and
4) a processor which is programmed with:
   a) an astronomical algorithm with a celestial catalog providing known known positions at specific times of at least two stars,
   b) an attitude transfer alignment algorithm between IMU and a telescope,
   c) software for computing heading based on measurements of positions of images of celestial objects on a focal plane array.

In preferred embodiments the telescope is Canon RF 70-200 mm F2.8 L IS USM lens from Canon USA Inc.; the shortwave infrared (SWIR) camera is Phoenix HD5 camera having 1280×1024 pixels from Attollo Engineering; IMU is P-1775 FOG IMU from KVH Industries Inc.; wheel speed sensors are the ACDelco GM Original Equipment 23498355 Front Wheel Speed Sensors. The clock is an Oven Controlled Cristal Oscillator from Microchip Technology Inc., and the processor is Intel® Xeon Quad Core processor from Intel Corporation integrated into Data Distribution Unit—Expandable (DDUx) II from Leonardo DRS.

Because for known time and approximate location positions of the stars are accurately known, accurate vehicle heading can be determined from the star images. In preferred embodiments the CNS continuously measure absolute heading relative to the Earth's true north with accuracy of 0.1 mrad and determine position without the use of pre-emplaced infrastructure and does not relay on the use of magnetic compass. Vehicle heading in conjunction with ground speed determined by a wheel speed sensor and roll and pitch determined by an IMU, vehicle position can be calculated using dead-reconning navigation algorithm without input from GPS. The CNS can operate in clear and partly cloudy sky when the line-of-sight (LOS) to celestial objects is unobscured. The SWIR camera linked to the processor records star images.

### Other Techniques

A CNS can operate as described above in clear and partly cloudy skies. For operation in the overcast conditions, other embodiments of the present invention can be equipped with imaging cameras pointed horizontally and vision-based navigation software developed by Leidos. A vision-based navigation software matches the camera image recorded from a moving vehicle's monocular camera to an image of what the camera would see at the true location within 3D reference model of the operating area produced from satellite imagery and available worldwide.

### Some SWIR Test Results

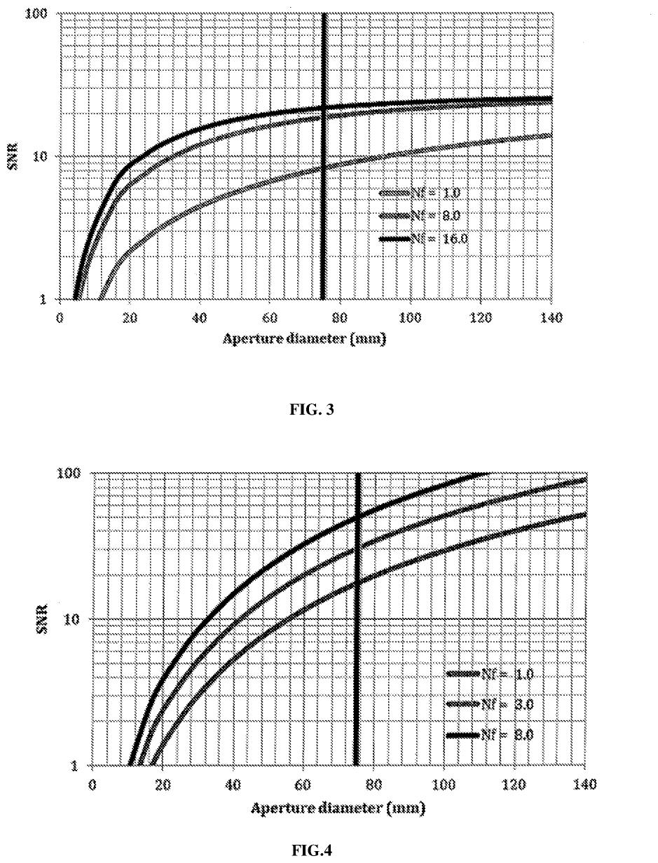

FIG. 3 and FIG. 4 present results of the radiometry analysis for imaging stars at daytime and at night, respectively, using SWIR sensor. The signal-to-noise ratio (SNR) for day, and terminator/night operation was calculated for a system based on a commercial SWIR camera with a 1.45 μm long-pass filter during daylight operation and no filter for terminator and night operation. In both cases a 15 msec exposures is assumed, corresponding to a frame rate of 67 frames-per-second, to freeze platform motion over a single exposure time. Multiple data frames will be shifted and added based on IMU measured residual platform motion combined with the known star slew rate.

SNR calculations are shown for daylight operation in FIG. 3 for a 25 μrad angular pixel size, or IFOV, over a range of telescope aperture diameters and different number of averaged data frames (Nf). The calculations are performed for H-band magnitude, m_{H}=3 star, and 1.45 μm long-pass filter, zenith observation, 23 km visibility maritime aerosol, 0.02% nonuniformity after correction. A MODTRAN model for atmospheric transmission and sky background was used in these calculations. From FIG. 3, it is seen that 8 frame average produces SNR=20 for 75 mm aperture, whereas 16 frame average produces SNR=20 for 50 mm aperture.

Similar results calculated for terminator/night operation and star with H-band magnitude m_{H}=4.5 are shown in FIG. 4. In this case, it is assumed that the optics spectral transmission is 90% for all IR wavelengths longer than 0.8 μm. These results illustrate that, stars brighter than H-band magnitude 4.5, can be detected (with a SNR=20) in a single frame with a 75 mm aperture. Applicants estimate that an 8-frame average will be required to achieve the same SNR with a 50 mm aperture. Thus, the radiometry analysis shows that a compact telescope having diameter of 50 mm-75 mm, or 2″ to 3″, with SWIR camera can record star images both at daytime and at night. Results of the radiometry analysis were compared with the field data, confirming the radiometry analysis.

The field test was performed using an 8-inch telescope with 320×240 pixels SWIR camera on equatorial mount that compensate for Earth's rotation by having one rotational axis, the polar axis, parallel to the Earth's axis of rotation. The angular pixel size is IFOV=28 μrad, and field-of-view (FOV) is 0.5×0.4 degrees.

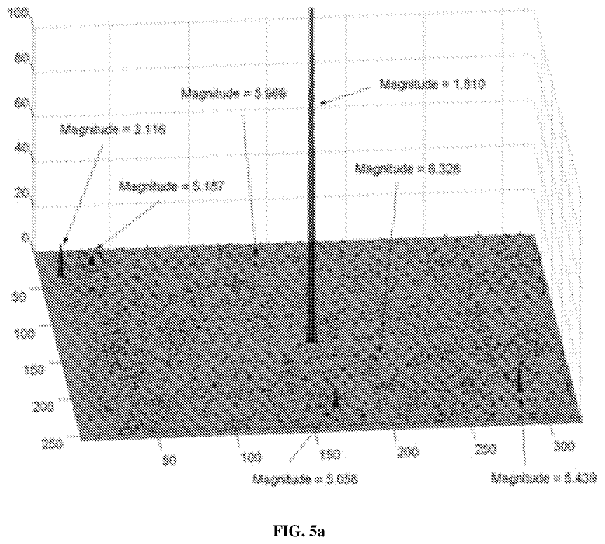

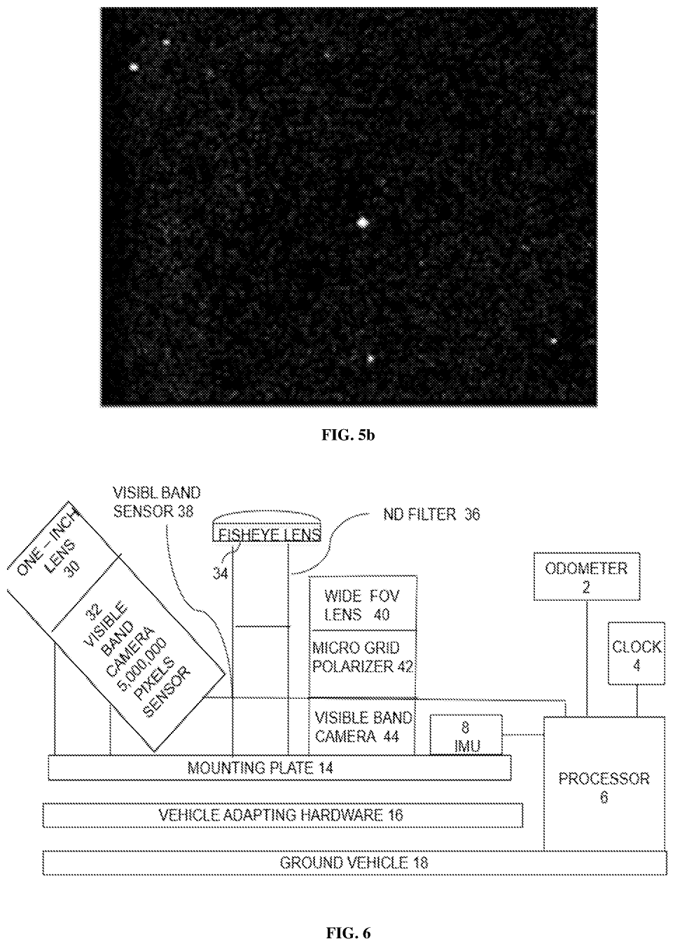

FIG. 5a shows a 3-D representation of the processed image obtained by averaging of 10 frames from the data set recorded at daytime at angular distance of 100 degrees from the sun. (Applicants' computer knows the names of these stars and identified them.) In this figure, the stellar brightness expressed in camera counts is plotted along the vertical axis. The horizontal axes are labeled in pixels. Seven stars having H-band magnitude in the range from 1.8 to 6.3 magnitude were detected and identified in the FOV of 0.4×0.5 degrees. The bright star in the center is the target star with high SNR. The smaller points represent dimmer stars that happen to be in the same FOV. The dimmest star that could be positively identified in the processed image was magnitude 6.3. This represents the star limiting magnitude for this combination of the telescope aperture diameter and exposure time for typical sky backgrounds. In addition, four stars have brightness ranging from H-band magnitude 5 to 6. FIG. 5b depicts 2-D plot corresponding to FIG. 5a. The image spot size of the brightest star in the center of the plot spans over multiple pixels, where a spot size of a dim star includes only fewer pixels. The centroid accuracy is high in both cases due to high values of the signal-to-noise ratio (SNR).

This high accuracy is explained below. According to J. S. Morgan, D. C Slater, J. G. Timothy, and E. B. Jenkins, “Centroid position measurements and subpixel sensitivity variations with the MAMA detector” Applied Optics, Vol. 28, No. 6,1178-1192 (1989), the rms centroid error for a single frame is given by

$$ε = \frac{3 π}{16} \frac{b}{SNR} ,$$

where b is the image spot size and

$$SNR = \frac{{I}_{s} - 〈 I 〉}{σ} .$$

Here Iₛ is the total signal intensity divided by number of pixels in the image, [symbol] l [symbol] is the mean intensity in the image, and σ is the rms noise. Even the spot size of the bright star is larger than that for dim star, the rms centroid error is small due to high SNR values.

Now we compare radiometry analysis with the field test data. The aperture diameter of the telescope in the field test was 200 mm, and it was 75 mm in the radiometry analysis. Therefore, the light collecting area in the field test was by a factor of (200 mm/75 mm)²=7.1× larger. In addition, an exposure time in the field test was 100 msec, and it was (15 msec×\sqrt{16 frams}=60 msec) in the radiometry analysis. Because the angular pixel size was about the same (25 μrad for test setup and 28 μrad for radiometry analysis), the experimental set up had a factor of 7.1×(100 msec/60 msec)=12× gain as compared to the system parameters used in the radiometric calculations. However, the FOV in the experimental setup with a 320×240 pixel sensor was 0.5×0.4 degrees, whereas if Phoenix HD5 SWIR camera with 1280×1024 pixels from Attollo Engineering with office in Camarillo, CA is used then the FOV of the sensor in the radiometry analysis will be 2 deg×1.7 deg, or by a factor of 4×4.26=17× greater. A large sensor FOV in the radiometry analysis compensates a factor of 12× gain in the experimental setup due to larger telescope aperture diameter and longer exposure time. Since, the star brightness in the daytime radiometry analysis (m_{H}=3) is the same as that in the field data (m_{H}=3.1), the radiometry analysis agrees with the test results.

Positions of celestial objects are known to very high precision, so the heading accuracy is limited mainly by the accuracy of the optics and sensor used to view them. For imaging stars at day and night a compact telescope and SWIR camera is mounted on the mounting plate. The telescope is pointed about 30 degrees from vertical. Using a lens (Canon RF 70-200 mm F2.8 L IS USM) from Canon USA Inc. with office in Melville, NY in conjunction with Phoenix HD5 SWIR camera having 1280×1024 pixels from Attollo Engineering with office in Camarillo, CA, an angular pixel size of IFOV=(5 μm/200 mm)=25 μrad and FOV=1.8 deg×1.5 deg will be provided.

Some parameters of interest for SWIR camera and lens are listed in Table 1 below.

TABLE 1
SWIR Camera and lens parameters

| | |
|---|---|
| Camera | |
| Detector Material | InGaAs |
| Spectral Response | 1.0 μm-1.65 μm |
| Pixel Pitch | 5 μm |
| Array Format | 1280 × 1024 |
| Quantum Efficiency | >65% |
| Frame Rate | 30 Hz, 60 Hz, 120 Hz (available |
| | on separate product Phoenix HD5 HS |
| Weight | 23 g (core, no lens) |
| Power Consumption | 1.6 W at 30 Hz 1.8 W at 60 Hz |
| Canon Lens | |
| Focal lens | 200 mm |
| f# | 2.8 |
| Field of view | 1.8 deg × 1.5 deg |

Low SWaP-C CNS

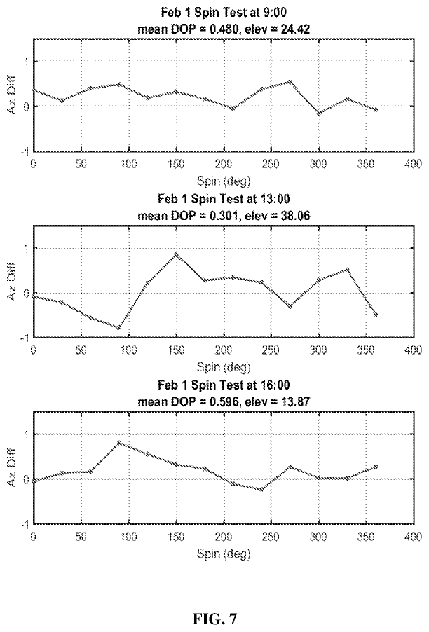

Preferred embodiments of the present invention also include a low Size, Weight and Power and Cost Celestial Navigation System (SWaP-C CNS) which includes separate daytime and nighttime camera systems is describe in FIG. 6. This embodiment includes a daytime sensor comprising a fisheye lens 34 with neutral density-6 (ND-6) filter 36 adapted to block portions of the sunlight to permit daytime viewing of the sun at daytime. A nighttime sensor comprising a wide FOV 1″ aperture diameter lens 30 and a visible-band CMOS camera 32 adapted for imaging stars at night. In preferred embodiments the fisheye lens in the daytime sensor is the DSL215 lens from Sunex Digital Imaging Optics, visible band camera is AR0521/D CMOS sensor from ONSEMI with at least 5,000,000 pixels, and the lens in nighttime sensor is Lensagon B3M50025 lens from Lensation GmbH. At night, the earth's true north reference, or non-magnetic heading, is determined from measurements of positions of two, or more, stars images on a focal plane array. At daytime, measurements of the gravity vector, or local vertical, by IMU 8 after application of the attitude transfer alignment algorithm are used in conjunction with the sun position on a focal plane array for heading determination. The heading rms error at daytime is 1 mrad, and it is 0.3 mrad at night.

FIG. 6 shows other important components of the preferred low SWaP-C CNS embodiment of the present invention. These are clock 4, odometer 2, low-cost IMU 8 and processor 6. The low SWAP-C CNS includes two celestial imaging sensors: a day sensor 31 and a nighttime sensor 33. The day celestial sensor includes a fisheye lens 34 with neutral density-6 (ND6) filter 36 and visible-band CMOS camera 32; The day camera having a fisheye lens with FOV of 185 deg is mounted to point in the vertical direction for daytime celestial observations of the sun. The preferred daytime camera is AR0521/D CMOS sensor from ONSEMI with offices in Phoenix, AZ, the fisheye leans is the DSL215 lens from Sunex Digital Imaging Optics with offices in Carlsbad, CA.

The night sensor includes a 1-inch lens 30 and visible-band CMOS camera 32. The nighttime lens 30 is Lensagon B3M50025 lens from Lensation GmbH with offices in Karlsruhe, Germany. The night camera has a 6.4 degrees×4.9 degrees FOV for nighttime celestial observations using stars. The night camera is mounted to point at about 30 degrees from vertical.

This embodiment may include a third imaging sensor (polarization compass) as shown in FIG. 6 includes a visible-band camera 44 with microgrid polarizer 42 and wide field-of view lens 40. This sensor records images of the sky, from which the Stokes parameters, degree of linear polarization (DoLP), and angle of polarization (AoP) are calculated. A nonmagnetic heading is determined from the angle of polarization (AoP) pattern, which is detectable without unobscured line-of-sight (LOS) to the sun and persists under the clouds. Polarization compass increases the availability of celestial solutions to include dawn and dusk and overcast conditions. The three visible band cameras and IMU are linked to the processor 6, which is used to record raw data (including images of celestial objects and IMU readings) and provide almost real time calculations. Because at daytime, only one celestial object, the sun is imaged; a local vertical, or gravity vector from the IMU is used for heading determination. Also, an attitude transfer alignment between the IMU to the day sensor is required. At night, when multiple (more than 5) stars are detected in each data frame, the heading is determined directly from star measurements. And knowledge of the gravity vector is not required.

At night, the earth's true north reference, for non-magnetic heading, is determined from measurements of positions of two, or more, stars images on a focal plane array. At daytime, measurements of the gravity vector, or local vertical, by the IMU after application of the attitude transfer alignment algorithm are used in conjunction with the sun position on a focal plane array for heading determination. The calculated heading rms error at daytime is 1 mrad, and it is 0.3 mrad at night.

Some parameters of interest for the daytime and nighttime cameras, a 185 degrees F.OV fisheye lens and nighttime lens are listed in Table 2. The weight and cost of key components are shown in Table 3. Total weight of the Low SWaP-C CNS is 194 g and total power is 1.65 W. The price of all hardware components is about $1,013.

TABLE 2
Daytime Camera, fisheye lens parameters

| | |
|---|---|
| Camera | |
| Pixel Pitch | 2.2 μm × 2.2 μm |
| Array Format | 2529(H) × 1944(V) 4/3 aspect ratio |
| Quantum Efficiency | >65% |
| Output | 8, 10, or 12 bit |
| Frame Rate | 30 Hz, 60 Hz, 120 Hz (available on |
| | separate product Phoenix HD5 HS |
| Power Consumption | 0.32 W Full resolution at 60 fps, 10 bit |
| Package Options | 12 mm × 12 mm |
| Daytime Fisheye Lens | |
| Focal lens | 1.55 mm |
| f# | 2.0 |
| Field of view | 185 degrees at 4.7 mmm image circle |
| Night Lens | |
| Focal lens | 50 mm |
| f# | 2.5 |
| Field of view | 1.8 deg × 1.5 deg |
| Weight | 34.5 g |
| Field of view | 6.4 degrees × 4.9 degrees. |

Table 3 shows that the FIG. 6 embodiment can be built using only light weight, Commercial Off-the-Shelf (COTS) components.

TABLE 3

Low SWAP-C CNS

| | | |
|---|---|---|
| COTS Component | Weight | Price |

| | | | |
|---|---|---|---|
| Sunex Daytime lens | 9 | grams | $40 |
| Lensagon B3M50025 nighttime lens | 35 | grams | $100 |

| | | |
|---|---|---|
| AR0521/D sensor from ONSEMI | 5 grams × 2 | $36 × 2 |

| | | | |
|---|---|---|---|
| STIM377H from SAFRAN | 55 | grams | $230 |
| (Sensonor) (IMU) | | | |
| OX-221 Oven Controlled Crystal | 9 | grams | $62 |
| Oscillator (clock) | | | |
| Xilinx Zynq microprocessor | 7 | gm | $132 |
| Electronic Processor Board | 14 | gm | $227 |
| Housing, connectors, circuit boards | 60 | grams | $150 |
| Low SWAP-C CNS Total: | 194 | grams | $1,013 |

Inertial Measurement Unit (IMU) is preferably the P-1775 IMU from KVH Industries with offices in Middletown, RI. It is a fiber-optic gyro (FOG)-based IMU with photonic integrated chip (PIC) technology that provides proven performance for a variety of environments and applications. The P-1775 IMU is the commercial-off-the-shelf (COTS) inertial measurement unit. The high-performing P-1775 IMU offers an advanced inertial sensor system and is designed for systems and applications where very high bandwidth, low latency and low drift are critical.

In its P-1775 IMUs KVH utilizes the proven technology of the DSP-1760 fiber optic gyroscopes (FOGs). These FOGs are then integrated with three low noise 10 g or 25 g accelerometers, as well as a 3-axis magnetometer for automatic gyroscope bias compensation even in environments with strong local magnetic fields. The P-1775 IMU with 25 g accelerometers is designed for highly dynamic applications and/or in applications with high levels of acceleration, vibration, or shock.

All KVH high-performance IMUs offer a compact package designed for drop-in replacement for many prior art IMUs. Flexible interface and programmable message outputs simplify the integration of the P-1775 IMU. The P-1775 IMU offers ease of integration for designers of higher-level inertial navigation, guidance, or stabilization systems by offering user-programmable features, including an adjustable baud rate so that communication latency can be adjusted to receive accurate, timely data. Ideal applications for the P-1775 IMU include those with challenging environments such as drilling, mining, pipeline inspection and maintenance, mobile mapping systems, and stabilization systems for radar, LIDAR, and high-speed gimbals.

The P-1775 IMU has the following specifications:
Input Rate (max)±490°/sec
Bias Instability (25° C.)≤0.1°/hr, 1σ (max), ≤0.05°/hr, 1σ (typical)
Bias vs. Temp. (≤° C./min)≤1°/hr, 1σ (max), ≤0.7°/hr, 1σ (typical)
Bias Offset (25° C.)±0.5°/hr Scale Factor Non-linearity (max rate, 25° C.)≤50 ppm, 1σ
Scale Factor vs. Temperature (≤1° C./min)≤100 ppm, 1σ
Angle Random Walk)(25° ° C.≤0.012°/√hr (≤0.7°/hr/√Hz)
Bandwidth (−3 dB)≥1000 Hz at data rates of 2300 to 5000 Hz≥440 Hz at data rate of 1000 Hz (default) Electrical/Mechanical Initialization Time (valid data)≤1.5 sec
Data Interface Asynchronous or Synchronous RS-422
Baud Rate Selectable 9.6 Kbps to 4147 Kbps
Data Rate User Selectable 1 to 5000 Hz
Dimensions (max) 88.9 mm Dia×73.7 mm H (3.5″×2.9″)
Weight (max) 0.7 kg (1.45 lbs)
Power Consumption 8 W (max), 5 W (typical)
Input Voltage +9 to +36 VDC Environment
Temperature (operating) −40° C. to +75° C. (−40° F. to +167° F.)
Shock (operating) 9 g, 11 msec,
sawtooth Vibration (operating) 8 g rms, 20-2000 Hz random
Accelerometers Input Limit (max)±10 g
Bias Instability (constant temp)<0.05 mg, 1σ
Scale Factor Temperature Sensitivity≤500 ppm/° ° C., 1σ (max) (full scale, full temp)
Velocity Random Walk)(25° ° C.≤0.12 mg/√Hz (0.23 ft/sec/√hr).

### Polarization Compass

Celestial Compass provides nonmagnetic heading information in clear and partly cloudy conditions, when celestial objects (sun, moon, or stars) are visible by day and night sensors. However, it cannot provide celestial solutions during dawn and dusk (approximately 40 min depending on the latitude) and under overcast conditions. To overcome this limitation, proposed invention can include a 3^{rd} sensor, polarization compass, which is known from a prior art (U.S. Pat. Nos. 9,423,484 B2 and 10,408,918 B2).

A physical basis for polarization measurements is the following: 1) Single Rayleigh scattering produces linear polarization of the sky light perpendicular to the plane of scattering defined by the points: observer, sun, and scattering point; 2) The polarization direction pattern forms circles about the sun-anti-sun axis for an observer at the center of the earth: 3) The highest degree of polarization is at 90 degrees from the sun; 4) The degree of linear polarization (DoLP) is affected by the presence of clouds and haze; 5) The direction of polarization, or angle of polarization (AoP) pattern persists under the clouds (R. Hegedus, S. Akesson, G. Horvath, “Polarization patterns of thick clouds: Overcast skies have distribution of the angle of polarization similar to that of clear skies,” JOSA A 24 (8) pp. 2347-2356 (2007)). The latter is because the AoP relates only to the residual polarized light, which is transmitted through the cloud, not the light scattered by the cloud; 6) The AoP pattern contains information about the celestial position of the sun and therefore allows us to determine nonmagnetic true north reference from the view of the sky when a line-of-sight (LOS) to the sun is obscured.

Polarization compass shown in FIG. 6 includes a visible-band camera with microgrid polarizer and wide field-of-view (FOV) lens. This sensor records images of the sky, from which the Stokes parameters, degree of linear polarization (DoLP), and angle of polarization (AoP) are calculated. A nonmagnetic heading is determined from AOP pattern, which is detectable both in clear sky and when LOS to the sun is obscured. Thus, polarization compass increases the availability of celestial solutions to include sunrise and sunset and overcast conditions.

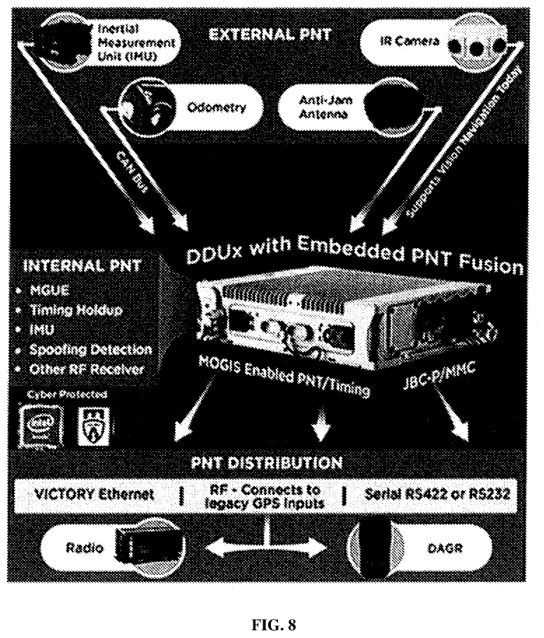

FIG. 7 presented azimuth measurements made using polarization compass that includes a wide FOV (60 degrees) lens, on-chip micro-grid polarizer, and visible band camera. The graph shows azimuth error in degrees vs azimuth in degrees for data collected at 9:00 am, 1:00 μm, and 4:00 pm. Polarization compass was mounted on a theodolite, and azimuth measurements made using polarization compass were compared with the theodolite readings when the unit was rotated in azimuth. It is seen that at 9:00 am DoLP=0.48, sun elevation angle is 24 deg, and rms azimuth error is 4 mrad. At 1:00 pm, DoLP=0.30, sun elevation angle is 38 deg, and rms azimuth error is 9 mrad. At 4:00 pm, DoLP=0.60, sun elevation angle is 14 deg, and rms azimuth error is 4 mrad.

The algorithm for heading determination uses the sky AoP pattern and pattern matching algorithm. The key steps for determining heading using sky polarization compass includes the following steps:
Record sky polarization images and create a digital library of wide angle AoP and DoLP reference images under clear sky conditions for a range of solar elevation angles
Record sky AoP and DoLP images for the current known location and time
Calculate the solar elevation angle for the current location and time using sun ephemerid
Select reference AoP image that matches the current solar elevation
Find the best match between the current and reference AoP images using pattern matching algorithm
Calculate current azimuth position of the Sun relative to the Sun position at the time of the reference image
Calculate True North reference
Determine vehicle heading

Note that the use of a pattern matching technique eliminates the need to account for the effect of the optical system on the state of polarization detected at each pixel because both current and reference images are recorded using the same optical setup. Also, a pattern matching algorithm requires rotation of the current AoP image in the range from −5° to +5° in azimuth with respect to the sun azimuth is the reference AoP image and calculation of the difference between AoP in the reference and current image. The peak position of the histogram of the AoP difference between current and reference images determines the sun azimuth in the current AoP image and True North reference.

Alternatively, in the pattern matching algorithm the AoP pattern calculated using single scattering Rayleigh theoretical model described in several good textbooks and papers including K. Coulson, “Characteristics of the radiation emerging from the top of Rayleigh atmosphere-I: intensity and polarization,” Planet. Space Sci.,” V.1, 265-276(1959); K. L. Coulson, “Polarization and intensity of light in the atmosphere,” Hampton, VA, A Deepak Publishing, 1988; and M. L. Brines and J. L. Gould, “Skylight polarization patters and animal orientation,” J. Exp. Biol. 96, 69-91 (1982) can be used for comparison with measured AoP image of the sky. However, in this case, in order to minimize, or eliminate, the effect of the measurement system on the AoP image an accurate system calibration is required.

The data presented in FIG. 7 was recorded using Sony polarization image sensor (IMX 264M) available from Lucid Vision Labs with headquarters in Richmond (British Columbia), Canada. This camera has 5.07M pixels, 3.45 μm pixel size, and 60 Hz frame rate. This sensor can capture a four directional polarization image in one shot by the four directional polarizer that is formed directly on chip under the on-chip lens layer, whereas with conventional types of polarization sensors, the polarizer is attached on top of the on-chip lens layer. A shorter distance between the polarizer and the photodiode improves the extinction ratio and the incident angle dependence. Since the polarizer is formed during the semiconductor process, from and formation of polarizer, uniformity, mass production and durability are excellent compared to conventional polarization sensors. Furthermore, Sony sensor is covered with an anti-reflection layer which helps to reduce reflectance and avoids poor flare and ghost characteristics.

### Wheel Speed Sensor

A speedometer measures and displays the instantaneous speed of a vehicle. Now universally fitted to motor vehicles, they started to be available as options in the early 20th century, and as standard equipment from about 1910 onwards. Many speedometers use a rotating flexible cable driven by gearing linked to the vehicle's transmission.

When the vehicle is in motion, a speedometer gear assembly turns a speedometer cable, which then turns the speedometer mechanism itself. A small permanent magnet affixed to the speedometer cable interacts with a small aluminum cup attached to shaft of the pointer on an analog speedometer instrument. As the magnet rotates near the cup, the changing magnetic field produces eddy current in the cup, which produces another changing magnetic field.

Many modern speedometers are electronic. In designs derived from earlier eddy-current models, a rotation sensor mounted in the transmission delivers a series of electronic pulses whose frequency corresponds to the (average) rotational speed of the driveshaft, and therefore the vehicle's speed, assuming the wheels have full traction. The sensor is typically a set of one or more magnets mounted on the output shaft or (in transaxles) differential crown wheel, or a toothed metal disk positioned between a magnet and a magnetic field sensor. As the part in question turns, the magnets or teeth pass beneath the sensor, each time producing a pulse in the sensor as they affect the strength of the magnetic field it is measuring. Alternatively, particularly in vehicles with multiplex wiring, some manufacturers use the pulses coming from the Anti-lock Braking System (ABS) wheel sensors which communicate to the instrument panel. Most modern electronic speedometers have the additional ability over the eddy current type to show the vehicle's speed when moving in reverse gear.

A computer converts the pulses to a speed and displays this speed on an electronically controlled, analog-style needle or a digital display. Pulse information is also used for a variety of other purposes by the full-vehicle control system, e.g. triggering an anti-breaking system (ABS) or traction control, calculating average trip speed, or to increment the odometer in place of it being turned directly by the speedometer cable.

Modern vehicles have four-wheel speed sensors: two front wheel speed sensors and two rear wheel speed sensors. Apart from monitoring vehicle functions such as traction control, wheel speed sensors form an integral part of a vehicle's ABS since they track the speed of the wheels and continuously send this information to the ABS controller. This information is interpreted by the controller to determine whether everything is in working order or whether it needs to activate the automatic brake and stop the car.

Passive wheel speed sensors were the first type of speed sensors to be installed with the ABS in modern cars. They function by delivering analog signals by means of alternating voltage to the ABS control unit. These days, vehicles are equipped with active wheel speed sensors, which record signals through a magnetic pulse. Some of the benefits of active wheel speed sensors include that they are:
Less sensitive to electromagnetic interference.
More compact and lighter than passive sensors
Insensitive to fluctuations in temperature or vibrations.
Able to detect the direction in which a wheel rotates.
Able to deliver digital output signals to the ABS controller.

A commonly used wheel speed sensors are ACDelco GM Original Equipment 23498355 Front Wheel Speed Sensors from Amazon with offices in Seattle, WA.

### Ground Speed Determination for Aerial Vehicles

The ground speed of the UAV can be determined using an imaging camera facing down and mounted on the belly of the UAV in conjunction with an image map matching software. Using a visible-band camera, imagery data of the environment at daytime can be collected. If a long wave infrared (LWIR) sensor is used, then imagery data is provided both day and night. Using satellite imagery data of the environment stored on board UAV, a ground velocity is calculated to within 1-2 m/sec using an image map matching software described in several references including Medrano M.” Estimation of the Ground Vector of an Aircraft using an Embedded Camera,” AIRBUS; Leiden, The Netherlands: ENSEEIN; Toulouse, France:2014; and Chmielewski P and Sibilski K., Ground Speed Optical Estimator for Miniature UAV,” Sensors (Basel), 2754 (2021).

An image map matching software allows the computation to be performed in real time using embedded microprocessor ranging from Jetson Nano for low-end UAV to Xavier NX for aerial platforms that fly much higher. Both microprocessors are from NVIDIA with offices in Santa Clara, CA. By combining the ground speed vector with vehicle attitude and heading information provided by the IMU and Celestial Compass, respectively, vehicle position is determined using dead reconning navigation method.

### Oven Controlled Cristal Oscillator

A temperature-controlled chamber of a crystal oven maintains a constant temperature of a quartz crystal oscillator preventing changes in frequency. Quartz crystals are widely used in electronic oscillators to precisely control the frequency produced. The frequency at which a quartz crystal oscillator vibrates depends on its physical dimensions. A change in temperature causes the quartz to expand or contract due to thermal expansion, changing the frequency of the signal produced by the oscillator. The oven is a thermally insulated enclosure containing the crystal and one or more electrical heating elements. Since other electronic components in the circuit are also vulnerable to temperature drift, usually the entire oscillator circuit is enclosed in the oven. The OX-221 Oven Controlled Crystal Oscillator from Microchip Technology Inc. with offices in Chandler, AZ has frequency stability of 10 parts-per-billion (PPB) and operating temperature range of −40° C. to +85° C.

### Data Distribution Unit-Expendable (DDUx) II & Processor

Leonardo DRS with offices in Arlington, VA developed Data Distribution Unit—Expandable (hereinafter “DDUx) II”) FIG. 8 and military variants, which are currently fielded on over 150,000 vehicles meaning this capability can be easily implemented without additional space or weight requirements. The DDUx II includes a powerful Intel-Xeon Quad Core processor from Intel Corporation with offices in Santa Barbara, CA. Convergence with the DDUx II also allows for ease of use as Assured Position, Navigation, and Timing (A-PNT) is embedded into the Battle Management System (BMS). The vehicle operator can use the BMS's Graphical User Interface (GUI) to view and manage GPS and A-PNT functions on a single screen. In addition, A-PNT distribution to all equipment of the vehicle is supported.

A fusion engine in the DDUx II combines system components in order to provide a reliable, GPS-denied navigation solution during real world jamming and/or spoofing attacks. This is hosted in the BMS and can be controlled via its GUI. FIG. 8 shows a block diagram DDUx II system. It includes M-Code receiver, Low Earth Orbiting (LEO) receiver, internal IMU with compass, and internal timing holdup. In addition, it includes external IMU/INS (various), vehicle odometry, video sensors for vision-based navigation with multiple options depending on sensor configuration: single front, dual: front/rear, and full 360. Multiple navigation algorithm options are optimized for a variety of environments from open desert to congested urban environments. The DDUx II includes a PNT distribution: RF distribution-feeds into existing GPS antenna inputs of legacy devices, like defense Advanced GPS Receiver (DAGR) or tactical radios; Victory Ethernet, serial, RS232 and RS422.

Key features and benefits provided by DDUx II:
Utilizes existing space claim—no need for additional space, weight, or safety certifications
Tailorable and scalable architecture
An Intel® Xeon Quad Core processor hosts several software packages including: PNT fusion, vision navigation, assured position navigation and timing (A-PNT) user interface, spoofing/jamming detection
A-PNT User Interface: 12″ touch-screen display and full-size keyboard
Supports A-PNT Distribution to all vehicle equipment
Easily swap out or add new components
Reduced training requirement to a single LRU
TRL 9, cyber-hardened hardware
Built by the Leonardo DRS Smart Manufacturing Center of Excellence.
   Lensagon B3M50025 lens

Lensagon B3M50025 lens shown at 30 in FIG. 6 from Lensation GmbH with offices in Karlsruhe, Germany, has the following specifications: focal length 50 mm, f #=2.5; clear aperture diameter=20 mm; optical distortion is 0.17% and weight is 34.5 g. If camera AR0521/D CMOS sensor 32 shown at 32 in FIG. 6 from ONSEMI is attached to the Lensagon B3M50025 lens, then an angular pixel size, or IFOV, is 44 μrad, and FOV is 6.3°×4.9°.

### Android Team Awareness Kit (ATAK)

Android Team Awareness Kit (ATAK) is an Android smartphone geospatial infrastructure and military situation awareness application. It allows for precision targeting, surrounding land formation intelligence, situational awareness, navigation, and data sharing. This Android app is a part of the larger TAK family of products. ATAK has a plugin architecture which allows developers to add functionality. This extensible plugin architecture that allows enhanced capabilities for specific mission sets (Direct Action, Combat Advising, Law Enforcement, Protection Operations, Border Security, Disaster Response, Off-grid Communications, Precision Mapping and Geotagging).

It enables users to navigate using GPS and geospatial map data overlayed with real-time situational awareness of ongoing events. The ATAK software represents the surrounding area using the military standard MIL-STD-2525B symbology, and customized symbols such as icons from Google Earth and Google Maps for iconography and the Cursor on Target data format standard for communication. Initially created in 2010 by the Air Force Research Laboratory, and based on the NASA World Wind Mobile codebase its development and deployment grew slowly, then rapidly since 2016.

As of 2020, ATAK has a growing base of 250,000 military and civilian users across numerous public safety agencies and US partner nations, and has seen the addition of 15 United States Department of Defense programs.

### Operation in Clear or Partly Cloudy Sky

Embodiments of the CNSs of the present invention can continuously measure absolute heading relative to the Earth's true north with accuracy of 0.1 mrad and determine position without the use of pre-emplaced infrastructure and does not rely on the use of magnetic compass. The CNS can operate in clear and partly cloudy sky when the line-of-sight (LOS) to celestial objects is unobscured. The SWIR camera linked to the processor records star images. Because for known time and approximate location positions of the stars are accurately known, accurate vehicle heading can be determined from the star images. Vehicle heading in conjunction with ground speed determined by an odometer and elevation determined by an IMU, vehicle position is calculated using dead-reconning navigation algorithm without input from GPS. The CNS can reliably operate in clear and partly cloudy sky, but it cannot operate in the presence of heavy clouds, fog, and smoke.

### Heavy Overcast Conditions

As indicated above in connection with the description of preferred embodiments, the primary components of the present invention cannot function as desired in overcast. For these reasons many embodiments can be equipped with a horizontally pointed imaging camera and vision-based navigator developed by Leidos with offices located in Reston VA (see J. Ryan et. al., “Using vision navigation and convolutional neural networks to provide absolute position aiding for ground vehicles,” Proceeding of SPIE, Volume 11758, Unmanned Systems Technology XXIII, 117580A (2021), incorporated herein by reference.

Leidos's Vision-Integrated Spatial Estimator (VISE) utilizes the Street-Level Image Matching (SLIM) deep-learning algorithm to provide absolute position measurement updates, which go beyond merely slowing inertial error growth but stop it altogether. SLIM matches the camera image recorded from a moving vehicle's monocular camera to an image of what the camera would see at the true location within 3D reference model of the operating area. These models are produced from satellite imagery and are available worldwide. They do not require pre-surveying by a forward asset. By fusing position estimates obtained using dead-reconning navigation method and vision-based navigator, accurate and robust navigation system will be provided for position determination in GPS denied or degraded environment.

### Distribution and Displaying of PNT Information

For military vehicles, PNT information may be displayed to the operator via Battle Management System (BMS) Graphical User Interface (GUI). On a single screen, vehicle, heading, velocity, position, and time will be displayed. This information will be overlayed with geospatial map data from Google Earth and Google Maps. In addition, PNT information can be radio frequency (RF) distribution-feed into existing Global Navigation Satellite System (GNSS) antenna inputs of legacy devices, like defense Advanced GNSS Receiver (DAGR), or Android Team Awareness Kit (ATAK), which is an Android smartphone geospatial infrastructure and military situation awareness application.

In order to display PNT information to the operator of civilian vehicle, similar Graphical User Interface (GUI) may be developed. Vehicle heading, velocity, position, and time may be displayed on a single screen in real-time with an update rate of 1 sec. In case of a robot and UAV, the PNT information can be transmitted via communication link to the operator at remote location. Any type of network or networks known in the art or future-developed, such as internet, Ethernet, WiFi, broadband over power line, coaxial cable and the like can be used.

### Initial Position Determination for Lost in Space Scenario

Embodiments of the present invention determine vehicle heading when initial position (within several kilometers) and time (within a second). In a “lost in space scenario” when initial vehicle position and attitude including heading are unknown, Celestial Compass can determine approximate initial position. To accomplish this goal, two modifications are required. First, a mounting plate 14 in FIG. 2 should be replaced with motorized rotation stage, and second a “lost-in space identification algorithm should be included in the CNS software.

Using motorized the rotation stage, a telescope 22 is pointed at the sky. The stars images are recorded and processed. The detected stars are identified using lost in space algorithms such as described in the following papers (D. Rijlaarsdam et. al. “A survey of lost-in-space star identification algorithms since 2009,” Sensors (Basel) 2020 May; 20(9); 2579; and F. Zhou and T. Ye, “Lost-in space star identification using planar triangle principal component analysis algorithm,” Mathematical Problems in Engineering,” Volume 2015, Article ID 982420). When using star catalog and lost-in-space star identification algorithm, the stars are identified, from the star position and local vertical, or gravity vector, determined by IMU, vehicle attitude (pitch, roll and heading) are determined. The corresponding calculations are described in several good textbooks including “Celestial Navigation Calculations (Upon Oceans Endorsement) Worked-out for Master 500GT Through 2^{Nd} Mate Unlimited,” Volume 3. By. A. Hickethier and H. Jia-Shen from Amazon. Next, from the star altitude above local horizon defined by gravity vector from IMU, a circle of equal altitude, or circle of position, is calculated. A vehicle can be located at any point of this circle. Then using motorized rotation stage, a telescope 22 is pointed at different area of the sky separated at large azimuth angular distance (more than 90 degrees) from the first region. The stars images are recorded and processed. When the stars are identified using lost-in-space star identification algorithm, the second circle of equal altitude is determined. An intersection of two circles determines approximate initial position of the vehicle. Measurement of the third star at different azimuth angle and the third circle of equal altitude will determine both vehicle initial position and position error. Using high accuracy CNS of the present invention, vehicle heading can be determined with accuracy of 0.1 mrad and vehicle position with accuracy of 600 m.

### Field Test Results

In order to validate proposed concepts, several field tests were performed. One test was conducted by recording star images using two-inch aperture diameter telescope with a CMOS camera on a moving car using different exposures. We found that when exposure time is <30 msec, the star images recorded from the car moving on the highway with speed of 60 mph, are not blurred. Based on this finding, we concluded that the aperture diameter of a night lens in Applicants' Celestial Compasses shall be increased from 3 mm up to 25 mm. Because the light collecting area is increased by a factor of (25 mm/3 mm)²=69, the exposure time is reduced from 1 sec down to 1 sec/69=14 msec.

A second test was conducted by imaging stars at night using a Lensagon B3M50025 lens and CMOS camera. The Lensagon B3M50025 lens was selected because it has small optical distortions and small form factor. An experimental setup used in data collection includes the Lensagon lens and the CMOS camera mounted on an optical plate attached to a tripod. An exposure time was 1 sec. The recorded star images were processed. In the processed image the number of star detections was limited to a maximum of 40. The dimmest star detected has catalog visual magnitude of 8.4, and rms residual error in identification fit is 55 μrad.

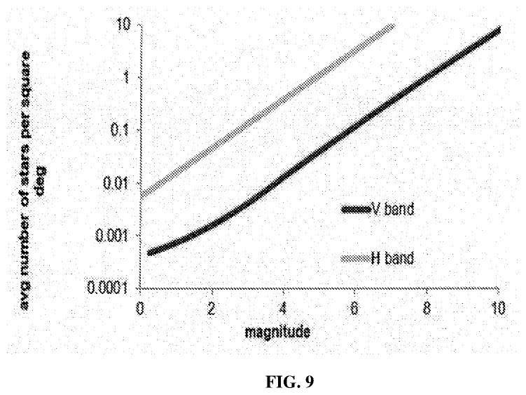

Next, we estimate expected number of stars in the FOV of the night sensor that can be detected with short exposures of 14 msec and Visible (V-band) limiting magnitude 7. FIG. 9 shows an average number of stars per square degree vs star magnitude in SWIR (H-band) and Visible (V-band). Because the FOV of the night sensor is 6.3°×4.9° an area is 31 deg², according to FIG. 9, the average number of stars detected with a visible band camera in the FOV of 31 deg² is (0.2 star/sq. deg×31 sq. deg=6 stars). This indicates that the low SWAP-C CNS concept of the present invention is feasible.

### Experimental Verification of UAV Navigation

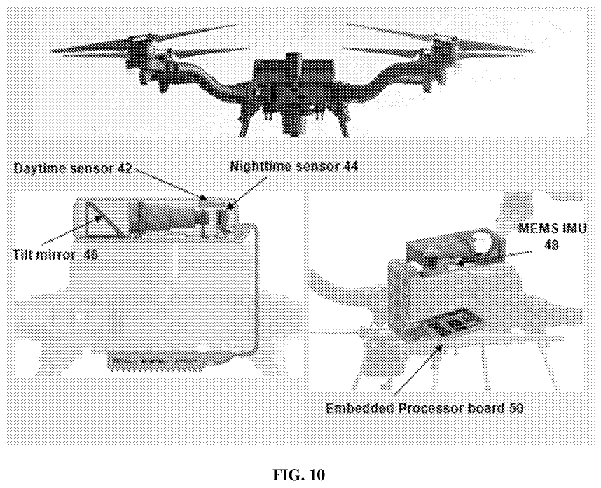

Applicants have proposed as described below utilizing embodiments of the present invention to control the navigation of a drone. Applicants have selected a small UAV, FreeFly Astro industrial drone, from Freefly Systems with headquarters in Woodinville, Washington U.S shown at 40 in FIG. 10. The experimental setup includes a daytime sensor 42 pointed straight up, a horizontally pointed Lensagon B3M50025 lens 44 with night camera and a tilt mirror 46 that points the night camera FOV at 30 deg of zenith. The setup also includes tactical-grade hermetic MEMS IMU STIM377H 48 from Safran Sensing Technologies with headquarters in Horten, Norway and embedded processor board 50. Heading measurements during UAV flight will be recorded. During daytime, heading will be determined using sun images in conjunction with gravity vector, or local vertical, measured by the tactical-grade IMU. During night, heading will be determined using multiple star images. Local vertical will not be required. Heading accuracy will be estimated by comparing heading measured by the processor with heading reference calculated using GPS position and drone attitude log from the drone flight control system.

### A Moving Ground Vehicle Demonstration

In case of a moving ground vehicle demo, a navigation-grade IMU (PHINS INS from iXblue Inc. with offices in Denver CO) can be used to provide high accuracy heading reference for comparison with heading measurements from low SWAP-C CNS. The navigation-grade PHINS INS with GPS adding has heading accuracy of 0.35 mrad, which is sufficient for evaluation of the heading accuracy of the preferred embodiment. The tactical-grade IMU (P-1775 from KVH) can be used to provide local vertical reference to for heading determination at daytime. Both IMUs and low SWAP-C CNS brassboard will be mounted on ground vehicle. The vehicle ground speed will be measured by ACDelco GM Original Equipment 23498355 Front Wheel Speed Sensors. The time reference will be provided by OX-221 Oven Controlled Crystal Oscillator from Microchip Technology. The Intel NUC 10 NUC 1017FNKN Mini PC will be used to run the LCNS software. At daytime, the heading will be determined using sun position on a focal plane array of the daytime sensor and local vertical from KVH P-1775 IMU. At night, the heading will be calculated using measurements of the star image positions on the night sensor.

Applicants will drive a ground vehicle between two selected points and record the heading measurements from LCNS and PHINS INS. The rms heading error using measurements from the optical and inertial sensors will be calculated.

### Benefits and Advantages Provided by CNSs of the Present Invention

The CNS provides the following benefits and advantages:
Nonmagnetic. Not sensitive to magnetic interference.
No performance degradation over time
No performance dependence on latitude
High accuracy CNS does not require knowledge of local vertical, or gravity vector, for heading determination. Consequently, azimuth accuracy does not depend on drifts and biases of the IMU and precision of the transfer alignment.
RMS heading measurement error is 0.1 mrad
Low SWAP CNS has total weight of 140 g and total power of 1.65 W
RMS heading error is 1 mrad at daytime and 0.3 mrad at night.
Allow for operation in urban environments, near power lines and other vehicles
Passive sensor. Does not reveal vehicle position.
Near zero startup time (heading measurements in 1 sec)
Can operate on different moving platforms including commercial and military ground vehicles, robots, and UAVs

### Variations

The above descriptions of preferred embodiments are examples of embodiments of the present invention and are not to be considered as exclusive in any sense. Persons skilled in the present art will recognize that many modifications and additions could be applied within the general scope invention including many features referred to in the Background Section of this application. For example, persons skilled will recognize that when celestial objects are not available fixes of many types could be available in addition to the Leidos technique. For example, a fix could be established merely looking at a road map and the clock. In any case the scope of the invention is to be determined by the appended claims and their legal equivalents.

Important applications of the invention include navigation of commercial and military ground vehicles in GPS denied or degraded environment, as well as navigation of robots, and unmanned platforms including UGVs and UAVs.

The CNS determines heading by imaging stars at daytime and night. It does not require knowledge of the gravity vector, or local vertical, for heading determination

Important applications of this invention include navigation of commercial and military ground vehicles in GPS denied or degraded environment, as well as navigation of robots, and unmanned platforms including UGVs and UAVs.

What is claimed is:

1. A celestial navigation system (CSN) for determining position and heading direction of a moving vehicle utilizing computer controlled dead reconning without input from GPS comprising:
A) a computer processor system,
1) programed with dead reckoning techniques for calculating current position and heading of the vehicle by using previously determined position information along with current estimates of ground speed, heading direction and course over elapsed time, and
2) programed with star catalogs and astronomical algorithms,
B) an onboard clock providing time,
C) a ground speed sensor adapted to provide current estimates of vehicle ground speed,
D) an inertial measurement unit (IMU) comprising:
1) three gyroscopes,
2) three accelerometers and
3) three magnetometers, and
E) one or more celestial cameras systems adapted to image celestial objects,
F) A display monitor displaying a map of the region surrounding the vehicle for continuously displaying the position of the vehicle within the surrounding region:
wherein the computer processor system is adapted to compare images of the celestial objects to images of the celestial objects in the star catalogs to provide position and heading of the vehicle when the celestial objects are viewable by the one or more celestial cameras, and
wherein the computer processor system is also programed to utilizes input from the on-board clock, the at-least one ground speed sensor and the IMU to calculate estimates of the position and heading of the vehicle when the celestial objects are not viewable by the one or more celestial cameras.

2. The CNS as in claim 1 wherein said position of the vehicle is provided in terms of latitude, longitude, and elevation.

3. The CNS as in claim 1 wherein the CNS is a high accuracy CNS wherein the one or more cameras systems is a single shortwave infrared (SWIR) camera system which includes a long-pass filter, and wherein the SWIR camera, and IMU are mounted on a mounting plate which is in turn mounted on ground vehicle with vehicle adapting hardware.

4. The CNS as in claim 3 wherein the telescope is mounted to point no closer to vertical than 30 degrees.

5. The CNS as in claim 3 wherein the telescope is mounted to point at about 45 degrees of vertical.

6. The CNS as in claim 3 wherein the position of the ground vehicle is determined by the processor using dead-reconning navigation algorithm and inputs from the onboard clock, the at least-one wheel speed sensor, the IMU, and star images recorded by the SWIR camera.

7. The CNS as in claim 3 wherein the short-wave infrared (SWIR) sensor is operating in the spectral band between 1 μm-1.7 μm.

8. The CNS of claim 3 wherein the same SWIR sensor is imaging stars at both daytime and night-time and the CNS does not require knowledge of the gravity vector, or local vertical, for heading determination.

9. The CNS of claim 1 where the CNS is a Low SWAP-C CNS wherein the one or more celestial cameras systems are two cameras system comprising:
A) a day-time camera system which includes a fisheye lens with neutral density (ND6) filter, a fisheye lens and visible-band CMOS sensor for daytime imaging of the sun mounted to point in the vertical direction for daytime viewing of the sun, and
B) a night camera having a FOV no larger than 1.8 degrees×1.5 degrees for nighttime celestial observations of stars.

10. The CNS of claim 9 and further comprising a polarization image camera comprising a polarization sensor with four directional (0 deg, 45 deg, 90 deg, and 135 deg) on-chip microgrid polarizer allowing to perform polarization measurements of the sky light during dawn and dusk and under overcast conditions when the line-of-sight (LOS) to the sun is obscured

11. The CNS of claim 1 wherein the computer processor is programmed with algorithm for calculations of the degree of linear polarization (DoLP) and angle of polarization (AoP) of the sky light, and heading

12. The CNS of claim 9 wherein the daytime fisheye lens has a FOV of greater than 180 degrees and the nighttime camera has a much smaller FOV of no greater than 6.4 degrees×4.9 degrees.

13. The CNS of claim 9 wherein the nighttime camera is mounted to point at 30 degrees of vertical and the night-time camera includes a 1″ lens and visible-band CMOS sensor and when multiple (≥5) stars are detected in each data frame, the heading is determined directly from star measurements and knowledge of the gravity vector is not required.

14. The CNS of claim 9 wherein the two cameras and IMU are linked to the processor, which is used to record raw data (including images of celestial objects, polarization measurements of the sky light, and IMU readings) and provide heading calculations within one second of real time.

15. The CNS of claim 9 wherein a local vertical, or gravity vector from IMU is used for heading determination during daytime.

16. The celestial navigation system as in claim 2 wherein a telescope is a 3″ Canon RF 70-200 mm F2.8 L IS USM lens from Canon USA.

17. The celestial navigation system as in claim 2 wherein a SWIR camera is Phoenix HD5 SWIR camera having 1280×1024 pixels from Attollo Engineering.

18. The celestial navigation system as in claim 2 where IMU is P-17750 FOG IMU from KVH Industries Inc.

19. The celestial navigation system as in claim 2 wherein wheel speed sensors are the ACDelco GM Original Equipment 23498355 Front Wheel Speed Sensors

20. The celestial navigation system as in claim 2 wherein the clock is an Oven Controlled Cristal Oscillator from Microchip Technology Inc.

21. The celestial navigation system as in claim 2 wherein the processor is Intel® Xeon Quad Core processor from Intel Corporation integrated into Data Distribution Unit—Expandable (DDUx) II from Leonardo DRS.

22. The celestial navigation system as in claim 9 wherein the long-pass filter is a 1.45 μm long-pass filter

23. The celestial navigation system as in claim 9 wherein a visible band camera is AR0521/D CMOS sensor from ONSEMI with at least 5,000,000 pixels

24. The celestial navigation system as in claim 9 wherein the lens of the visible band camera is the DSL215 lens from Sunex Digital Imaging Optics.

25. The celestial navigation system as in claim 9 wherein the lens of the visible band sensor is Lensagon B3M50025 lens from Lensation GmbH.

26. The CNS of claim 1 where the CNS is a Low SWAP-C CNS wherein the one or more celestial cameras systems is three cameras system comprising:
A) a day-time camera system which includes a fisheye lens with neutral density (ND6) filter, a fisheye lens and visible-band CMOS sensor for daytime imaging of the sun mounted to point in the vertical direction for daytime viewing of the sun, and
B) a night camera having a smaller FOV for nighttime celestial observations of stars, and
C) polarization image camera for polarization measurements of the sky light at daytime.

27. The celestial navigation system as in claim 25 wherein the polarization camera includes Sony polarization image sensor (IMX 264M).
